(19) United States
(12) Patent Application Publication
(10) Pub. No.: US 2019/0344451 A1
(43) Pub. Date: Nov. 14, 2019

(54) ROBOT, CONTROL DEVICE, AND CONTROL METHOD FOR ROBOT

(71) Applicant: Seiko Epson Corporation, Tokyo (JP)

(72) Inventors: Yasunaga MIYAZAWA, Okaya (JP); Hideaki OKA, Minowa (JP); Toshiyuki KAMIYA, Fujimi (JP)

(21) Appl. No.: 16/410,011

(22) Filed: May 13, 2019

(30) Foreign Application Priority Data
May 14, 2018 (JP) 2018-093228

(51) Int. Cl. B25J 13/08; B25J 9/16

(52) U.S. Cl. CPC B25J 13/085; B25J 9/1653; B25J 9/1674

(57) ABSTRACT

A robot includes a robot arm, a first force sensor configured to detect an external force, and a vibration sensor configured to detect vibration of the robot arm. The robot resets the first force sensor based on a detection value of the vibration sensor. The force sensor is desirably provided further on a proximal end side than the robot arm.

The present application is based on, and claims priority from JP Application Serial Number 2018-093228 filed May 14, 2018, the disclosure of which is hereby incorporated by reference herein in its entirety.

### BACKGROUND

### 1. Technical Field

The present disclosure relates to a robot, a control device, and a control method for the robot.

### 2. Related Art

A human-interactive type robot is a robot that shares a work space with a human and performs work in cooperation with the human.

For example, a human-interactive type robot described in JP-A-2016-112627 (Patent Literature 1) includes a robot arm, a robot wrist flange attached to the distal end of the robot arm, and a gripping hand provided at the distal end of the robot wrist flange. Such a human-interactive type robot can perform work for, for example, gripping work with the gripping hand and moving the work to a target place.

On the other hand, since the human-interactive type robot shares the work pace with the human, the human-interactive type robot is likely to unintentionally come into contact with the human.

Therefore, the human-interactive type robot described in Patent Literature 1 includes a force sensor configured to measure a force received by the robot from the outside and output a measurement value, a force-detection-value calculating section configured to subtract a correction value from the measurement value to calculate a force detection value, and a correction-value updating section configured to update the correction value to a force detection value calculated when a condition that the robot is stopped or is moving at constant speed and a fluctuation width of the force detection value in a predetermined unit time is equal to or smaller than a threshold is satisfied.

Since the force sensor is provided in the human-interactive type robot, the human-interactive type robot monitors a contact force between the robot and the human.

On the other hand, even when a force of the same magnitude acts on the force sensor, a detection value deviates from an actual value because of aged deterioration, electrification, a temperature change, a humidity change, and the like.

Therefore, in the human-interactive type robot described in Patent Literature 1, the force sensor is corrected (reset) when an inertial force involved in acceleration or deceleration does not act on the robot. Consequently, it is possible to keep the accuracy of the force sensor in a satisfactory state. The safety of the human-interactive type robot is improved.

However, in the human-interactive type robot described in Patent Literature 1, the force sensor is reset when the condition that the robot is stopped or is moving at the constant speed and the fluctuation width of the force detection value in the predetermined unit time is equal to or smaller than the threshold is satisfied. Therefore, it is likely that collision of the robot arm with an object cannot be accurately detected.

### SUMMARY

A robot according to an application example of the present disclosure includes: a robot arm; a first force sensor configured to detect an external force; and a vibration sensor configured to detect vibration of the robot arm. The robot resets the first force sensor based on a detection value of the vibration sensor.

### BRIEF DESCRIPTION OF THE DRAWINGS

FIG. 1 is a perspective view showing a robot according to a first embodiment of the present disclosure.

FIG. 2 is a block diagram of the robot shown in FIG. 1.

FIG. 3 is a flowchart for explaining a control method for the robot shown in FIGS. 1 and 2.

FIG. 4 is a diagram showing frequency characteristics based on detection values of a vibration sensor included in the robot shown in FIGS. 1 and 2.

FIG. 5 is a diagram showing frequency characteristics based on detection values of the vibration sensor included in the robot shown in FIGS. 1 and 2.

FIG. 6 is a diagram showing frequency characteristics based on detection values of the vibration sensor included in the robot shown in FIGS. 1 and 2.

FIG. 7 is a flowchart for explaining a control method for a robot according to a second embodiment of the present disclosure.

FIG. 8 is a perspective view showing a robot according to a third embodiment of the present disclosure.

FIG. 9 is a perspective view showing a robot according to a fourth embodiment of the present disclosure.

### DESCRIPTION OF EXEMPLARY EMBODIMENTS

Preferred embodiments of the present disclosure are explained below with reference to the accompanying drawings.

### First Embodiment

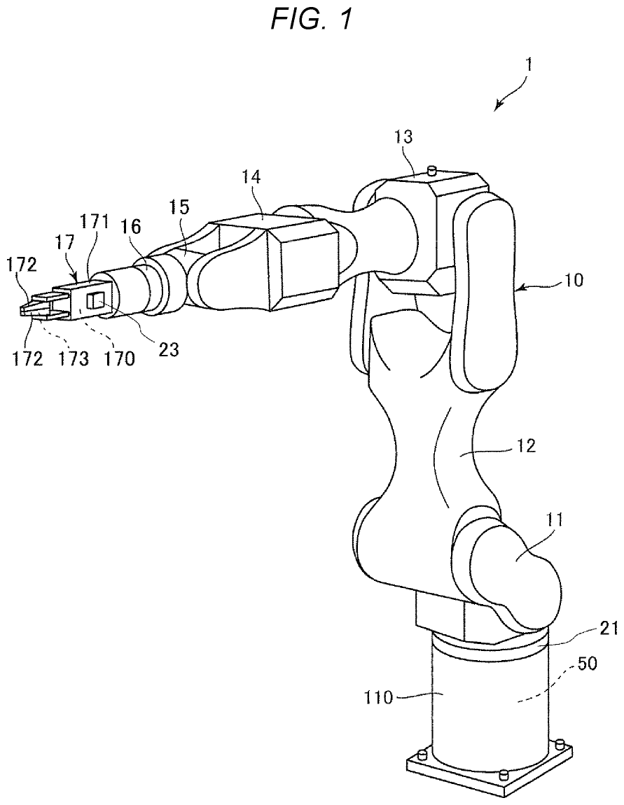

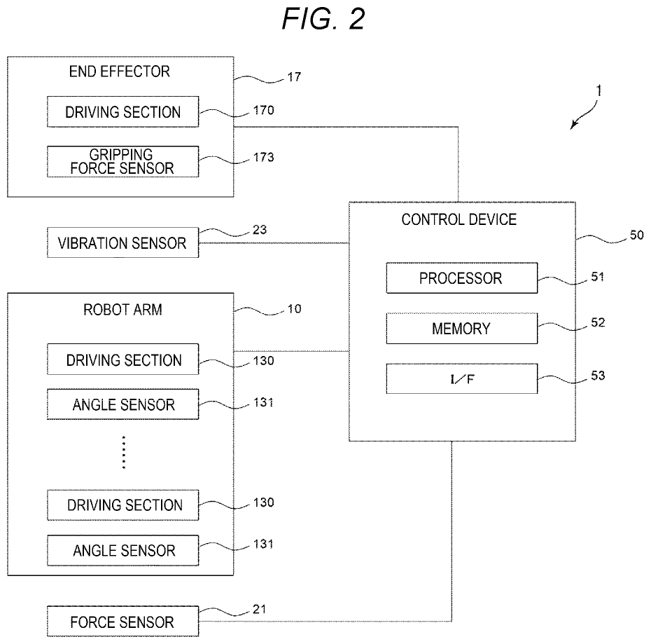

FIG. 1 is a perspective view showing a robot according to a first embodiment of the present disclosure. FIG. 2 is a block diagram of the robot shown in FIG. 1. In the following explanation, abase 110 side of a robot 1 is referred to as “proximal end side” and the opposite side of the base 110 side (an end effector 17 side) is referred to as “distal end side”.

The robot 1 shown in FIG. 1 is a system that performs work such as supply, removal, conveyance, and assembly of a precision instrument and components (target objects) configuring the precision instrument using a robot arm 10 attached with an end effector 17. The robot 1 includes the robot arm 10 including a plurality of arms 11 to 16, the end effector 17 attached to the distal end side of the robot arm 10, and a control device 50 configured to control movements of the robot arm 10 and the end effector 17. First, an overview of the robot 1 is explained below.

The robot 1 is a so-called six-axis vertical articulated robot. As shown in FIG. 1, the robot 1 includes the base 110 and the robot arm 10 turnably coupled to the base 110.

The base 110 is fixed on, for example, a floor, a wall, a ceiling, or a movable truck. The robot arm 10 includes an arm 11 (a first arm) turnably coupled to the base 110, an arm 12 (a second arm) turnably coupled to the arm 11, an arm 13 (a third arm) turnably coupled to the arm 12, an arm 14 (a fourth arm) turnably coupled to the arm 13, an arm 15 (a fifth arm) turnable coupled to the arm 14, and an arm 16 (a sixth arm) turnably coupled to the fifth arm 15. A portion that relatively bends or turns two members coupled to each other among the base 110 and the arms 11 to 16 configures a “joint section”.

As shown in FIG. 2, the robot 1 includes a driving section 130 configured to drive joint sections of the robot arm 10 and an angle sensor 131 configured to detect driving states (e.g., rotation angles) of the joint sections of the robot arm 10. The driving section 130 includes, for example, a motor and a speed reducer. The angle sensor 131 includes, for example, a magnetic or optical rotary encoder.

The end effector 17 is attached to the distal end face of the arm 16 of the robot 1. A force sensor may be disposed between the arm 16 and the end effector 17.

The end effector 17 is a gripping hand that grips a target object. The end effector 17 includes, as shown in FIG. 1, a main body 171, a driving section 170 set in the main body 171, a pair of gripping sections 172 opened and closed by a driving force applied from the driving section 170, and a gripping force sensor 173 provided in the gripping section 172.

The driving section 170 includes, for example, a motor and a transmission mechanism such as a gear configured to transmit a driving force of the motor to the pair of gripping sections 172. The pair of gripping sections 172 is opened and closed by the driving force applied to the driving section 170. Consequently, it is possible to grip and hold the target object between the pair of gripping sections 172 and release the target object held between the pair of gripping sections 172. The gripping force sensor 173 is a pressure sensor of a resistance type, an electrostatic type, or the like. The gripping force sensor 173 is disposed in the gripping section 172 or between the gripping section 172 and the driving section 170. The gripping force sensor 173 detects a force applied between the pair of gripping sections 172. The end effector 17 is not limited to the gripping hand and may be, for example, an end effector of a type for holding the target object with suction. In this specification, “holding” is a concept including both of the suction and the gripping. The “suction” is a concept including suction by a magnetic force and suction by a negative pressure. The number of fingers of the gripping hand used in the end effector 17 is not limited to two and may be three or more.

The control device 50 shown in FIGS. 1 and 2 has a function of controlling driving of the robot arm 10 based on a detection result of the angle sensor 131. The control device 50 has a function of, based on a detection result of the gripping force sensor 173 and operation conditions of the robot 1, determining a gripping force of the end effector 17 and changing the operation conditions of the robot 1.

The control device 50 includes a processor 51 such as a CPU (Central Processing Unit), a memory 52 such as a ROM (Read Only Memory) or a RAM (Random Access Memory), and an I/F (interface circuit) 53. The processor 51 reads and executes, as appropriate, computer programs stored in the memory 52, whereby the control device 50 realizes processing such as control of the movements of the robot 1 and the end effector 17, various arithmetic operations, and determination. The I/F 53 is configured to be communicable with the robot 1 and the end effector 17.

In FIG. 1, the control device 50 is disposed in the base 110 of the robot 1. However, the control device 50 is not limited to this and may be disposed, for example, on the outside of the base 110 or in the robot arm 10. A display device including a monitor such as a display, for example, an input device including a mouse and a keyboard may be connected to the control device 50.

The robot 1 shown in FIGS. 1 and 2 includes a force sensor 21 (a first force sensor) provided further on the proximal end side than the robot arm 10 and between the robot arm 10 and the base 110.

The force sensor 21 is a sensor that detects an external force applied to the robot arm 10. By providing the force sensor 21, when an external force is applied to the arm 16 or the end effector 17, the external force is transmitted to the force sensor 21 through the robot arm 10. The force sensor 21 can detect the magnitude and the direction of the external force. Consequently, it is possible to detect collision.

Further, the robot 1 shown in FIGS. 1 and 2 includes a vibration sensor 23 provided in the end effector 17. By providing the vibration sensor 23, it is possible to indirectly detect whether a person or an object is in contact with the robot arm 10. A detection result of the vibration sensor 23 is one of conditions for executing reset of the force sensor 21. The reset means that, for example, an output value of the force sensor 21 is corrected to a 0 level.

The vibration sensor 23 is a sensor that detects vibration of the robot arm 10. Examples of the vibration sensor 23 includes an acceleration sensor, an angular velocity sensor, an inertial sensor such as a combo sensor including both of the acceleration sensor and the angular velocity sensor, an optical vibration sensor, and a soundwave-type vibration sensor. In particular, the inertial sensor is desirably used.

The control device 50 shown in FIGS. 1 and 2 further has a function of resetting the force sensor 21 based on a detection result of the vibration sensor 23.

The I/F 53 (the interface) is configured to be communicable with the force sensor 21 and the vibration sensor 23.

The overview of the robot 1 is explained above. However, when an external force is applied to the robot 1, the robot 1 highly accurately detects the external force in the force sensor 21 and moves according to the external force. At this time, the force sensor 21 is reset at appropriate timing to maintain high detection accuracy. In other words, the force sensor 21 is not allowed to be reset at inappropriate timing and is reset at appropriate timing to prevent deterioration in detection accuracy. As a result, in the robot 1, high detection accuracy can be maintained concerning the force sensor 21. Therefore, the robot 1 can more accurately perform target work, for example, work for gripping and conveying an object. This point is explained in detail below.

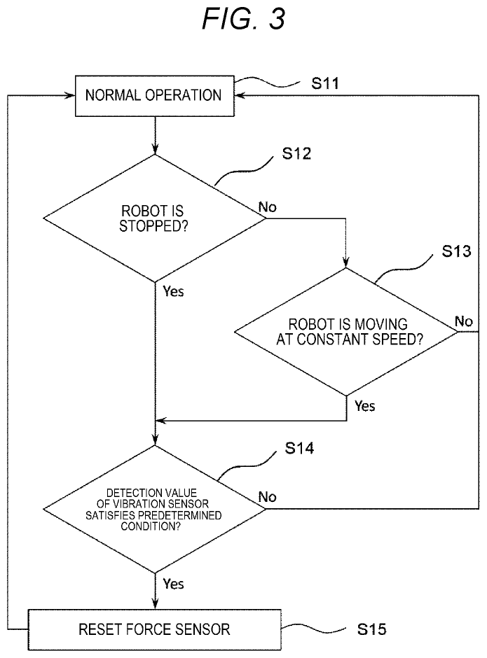

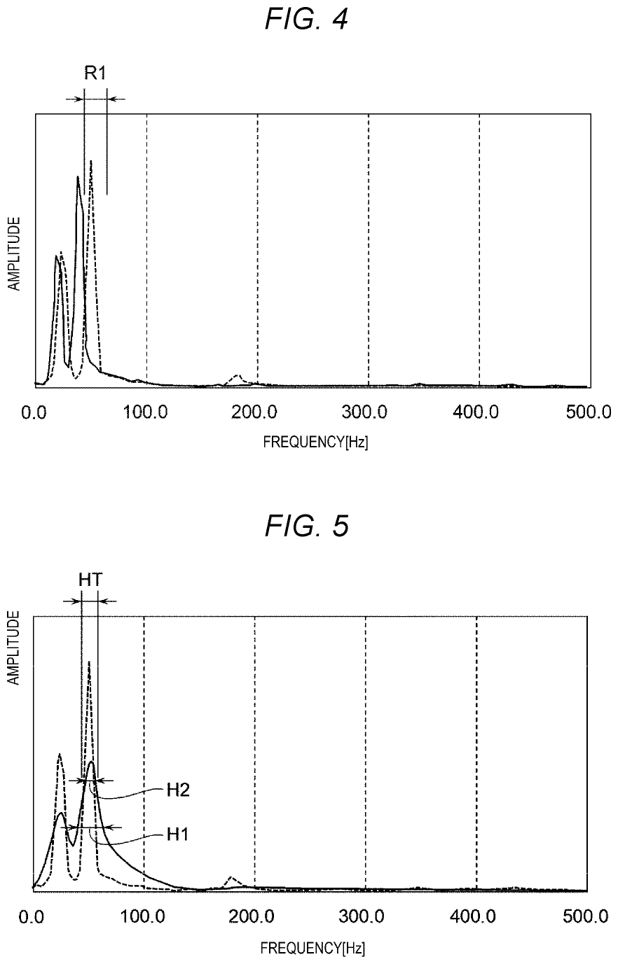

FIG. 3 is a flowchart for explaining a control method (a control method by the control device 50) for the robot shown in FIGS. 1 and 2. FIGS. 4 to 6 are respectively diagrams showing frequency spectra based on detection values of the vibration sensor included in the robot 1 shown in FIGS. 1 and 2.

First, the robot 1 starts a normal operation (step S11). Examples of the normal operation include work such as supply, removal, conveyance, and assembly of a precision instrument and components (target objects) configuring the precision instrument.

After the normal operation is started, the control device 50 determines whether the robot 1 is stopped (step S12). Specifically, based on the angle sensor 131 set in the robot arm 10, when all of the movements of the arms 11 to 16 are stopped, the control device 50 determines that the robot 1 is stopped. When any one of the arms 11 to 16 moves, the control device 50 determines that the robot 1 is not stopped.

When determining that the robot 1 is stopped (Yes in step S12), the control device 50 shifts to step S14 explained below.

On the other hand, when determining that the robot 1 is not stopped (No in step S12), the control device 50 determines whether the robot 1 is moving at constant speed (step S13). That is, the control device 50 determines whether the speed of the robot 1 during the movement is constant. Specifically, based on the angle sensor 131 included in the robot arm 10, when all of moving arms among the arms 11 to 16 are moving at constant angular velocity, the control device 50 determines that the robot 1 is moving at the constant speed. When any one of the arms 11 to 16 is moving at nonconstant angular velocity, that is, at temporally changing angular velocity (accelerating or decelerating), the control device 50 determines that the moving speed of the robot 1 is not constant.

When determining that the robot 1 is moving at the constant speed (Yes at step S13), the control device 50 shifts to step S14 explained below.

On the other hand, when determining that the moving speed of the robot 1 is not constant (No in step S13), since a point in time of the determination is not suitable as timing for executing the reset of the force sensor 21, the control device 50 returns to the normal operation (step S11) explained above.

When determining that the robot 1 is stopped or when determining that the robot 1 is moving at the constant speed, the control device 50 determines whether a detection value of the vibration sensor 23 satisfies a predetermined condition (step S14). Specifically, the control device 50 determines whether a detection value of the vibration sensor 23 provided in the robot arm 10 satisfies a condition instructed in advance. Examples of the condition instructed in advance include a specific frequency of the robot arm 10 and the amplitude of the specific frequency.

FIG. 4 is a graph showing frequency characteristics (frequency spectra) of detection values of the vibration sensor 23. The frequency characteristics mean results calculated by frequency spectrum estimation processing such as fast Fourier transform concerning the detection values of the vibration sensor 23. The graph of FIG. 4 is an example of the frequency characteristics. The horizontal axis corresponds to a frequency of vibration and the vertical axis corresponds to amplitude. In FIG. 4, a frequency characteristic, when an object is in contact with the robot arm 10 is indicated by a solid line. A frequency characteristic, when the object is not in contact with the robot arm 10, is indicated by a broken line.

When the robot arm 10 is not in contact with the object, peaks at specific frequencies are seen in a frequency spectrum of a detection value output from the vibration sensor 23. Some of these peaks correspond to an eigen frequency of the robot arm 10. Such frequency characteristics such as the peaks of the frequencies and waveforms of the peaks change when a person or an object comes into contact with the robot arm 10. Therefore, by monitoring the frequency characteristics as indicators, it is possible to indirectly grasp that the person or the object is in contact with the robot arm 10.

Therefore, in step S14, it is possible to determine whether the detection value of the vibration sensor 23 satisfies the predetermined condition according to, for example, whether a specific frequency is included in a frequency range R1 shown in FIG. 4. When the position of a peak of a frequency spectrum indicated by the broken line in FIG. 4 is within the frequency range R1, the control device 50 determines that the detection value of the vibration sensor 23 satisfies the predetermined condition.

On the other hand, in the case of FIG. 4, when the object comes into contact with the robot arm 10, the specific frequency decreases by approximately ten to twenty hertz. That is, FIG. 4 is an example of a change in the specific frequency. As a result of such a decrease in the specific frequency, the position of a peak of a frequency spectrum indicated by the solid line in FIG. 4 deviates from the frequency range R1. In this case, the control device 50 determines that the detection value of the vibration sensor 23 does not satisfy the predetermined condition.

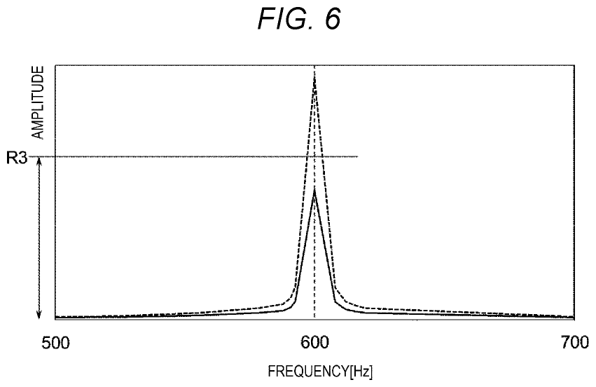

Concerning step S14, an example different from the example shown in FIG. 4 is explained with reference to FIGS. 5 and 6.

A graph of FIG. 5 is an example of frequency characteristics. The horizontal axis corresponds to a frequency of vibration and the vertical axis corresponds to amplitude. In FIG. 5, a frequency characteristic, when an object is in contact with the robot arm 10, is indicated by a solid line. A frequency characteristic, when the object is not in contact with the robot arm 10 is indicated by a broken line.

In step S14, it is possible to determine whether the detection value of the vibration sensor 23 satisfies the predetermined condition according to, for example, as shown in FIG. 5, a half value width of a peak waveform of a frequency spectrum. When a threshold of the half value width is represented as HT and half value widths of peak waveforms of frequency spectra of detection values are represented as H1 and H2, it is possible to determine whether the detection value of the vibration sensor 23 satisfies the predetermined condition according to whether the half value width H2 exceeds the threshold HT. When the half value width H2 is equal to or smaller than the threshold HT of the half value width as in a peak waveform of a frequency spectrum indicated by the broken line in FIG. 5, the control device 50 determines that the detection value of the vibration sensor 23 satisfies the predetermined condition.

On the other hand, when the object comes into contact with the robot arm 10, in some case, the half value width of the peak waveform of the frequency spectrum increases and the peak waveform draws a broad curved line. As a result of such an increase in the half value width, in a peak waveform of a frequency spectrum indicated by the solid line in FIG. 5, the half value width H1 exceeds the threshold HT of the half value width. In this case, the control device 50 determines that the detection value of the vibration sensor 23 does not satisfy the predetermined condition.

A graph of FIG. 6 is an example of frequency characteristics. The horizontal axis corresponds to a frequency of vibration and the vertical axis corresponds to amplitude. In FIG. 6, a frequency characteristic, when an object is in contact with the robot arm 10, is indicated by a solid line. A frequency characteristic, when the object is not in contact with the robot arm 10, is indicated by a broken line.

In step S14, it is possible to determine whether the detection value of the vibration sensor 23 satisfies the predetermined condition according to whether a peak value of a peak waveform of a frequency spectrum is, for example, equal to or larger than or smaller than a threshold R3 shown in FIG. 6. When the peak value is equal to or larger than the threshold R3 as in the peak waveform of the frequency spectrum indicated by the broken line in FIG. 6, the control device 50 determines that the detection value of the vibration sensor 23 satisfies the predetermined condition.

On the other hand, as shown in FIG. 6, when the object comes into contact with the robot arm 10, in some case, the peak value of the peak waveform of the frequency spectrum decreases. That is, FIG. 6 is an example in which the peak value of the peak waveform of the frequency spectrum changes. When a peak value of a peak waveform of a frequency spectrum indicated by the solid line in FIG. 6 is smaller than the threshold R3, the control device 50 determines that the detection value of the vibration sensor 23 does not satisfy the predetermined condition.

When determining that the detection value of the vibration sensor 23 does not satisfy the predetermined condition as explained above (No in step S14), since a point in time of the determination is not suitable as timing for executing the reset of the force sensor 21, the control device 50 returns to the normal operation (step S11) explained above.

On the other hand, when determining that the detection value of the vibration sensor 23 satisfies the predetermined condition (Yes in step S14), the control device 50 executes the reset of the force sensor 21 (step S15).

In the above explanation, the example is explained in which the peak position of the frequency spectrum shifts to the low-frequency side when the object comes into contact with the robot arm 10. However, the peak position of the frequency spectrum may shift to the high-frequency side when the object comes into contact with the robot arm 10. Similarly, the example is explained in which the peak value of the frequency spectrum decreases when the object comes into contact with the robot arm 10. However, the peak value of the frequency spectrum may increase when the object comes into contact with the robot arm 10. Similarly, the example is explained in which the half value width of the peak waveform of the frequency spectrum increases when the object comes into contact with the robot arm 10. However, the half value width of the peak waveform of the frequency spectrum may decrease when the object comes into contact with the robot arm 10. Two or more of the patterns shown in FIGS. 4 to 6 may be adopted in combination. The reset of the force sensor 21 may be executed based on the combination of the patterns.

A frequency characteristic of an output of the vibration sensor changes according to the posture of the robot arm 10. Therefore, the frequency, the threshold concerning the amplitude, and the determination standard set as R1, HT, and R3 may dynamically change.

As explained above, the reset of the force sensor 21 means, for example, offsetting the measurement value of the force by the force sensor 21 to zero (or any value). That is, the measurement value of the force by the force sensor 21 is corrected such that the measurement value can be regarded as zero (or any value). When the robot 1 is stopped or when the robot 1 is moving at the constant speed and a person or an object is not in contact with the robot arm 10, an external force is not applied to the robot arm 10. Therefore, it is possible to more accurately offset the measurement value by executing the reset of the force sensor 21 at such timing. As a result, thereafter, in measurement of a force by the force sensor 21, it is possible to minimize deviation between a measurement value and a true value. Consequently, since the measurement value after the correction of the force sensor 21 is close to the true value, it is possible to further stabilize the movement of the robot 1.

Such a control method for the robot 1 is performed by the control device 50. Specifically, the control device 50 includes, as explained above, the memory 52 (a storing section) and the processor 51 (a processing section). The memory 52 stores instructions readable by a computer. The processor 51 resets the force sensor 21 based on the instructions stored in the memory 52 and a detection value of the vibration sensor 23.

Therefore, in the examples shown in FIGS. 4 to 6, first, the processor 51 (the processing section) of the control device 50 acquires a detection value of the vibration sensor 23 and calculates a frequency characteristic of the detection value of the vibration sensor 23. The processor 51 determines whether the frequency characteristic satisfies the instructions stored in the memory 52, that is, instructions of the frequency range R1, the threshold R3, the threshold HT of the half value width of the peak waveform of the frequency spectrum, and the like and resets the force sensor 21. Consequently, since the control device 50 can efficiently execute reset, it is possible to highly frequently perform the reset of the force sensor 21.

The control device 50 performs steps S11, S12, S13, S14, and S15 explained above.

The instructions of the frequency range R1, the threshold R3, the threshold TH of the half value width of the peak waveform of the frequency spectrum, and the like stored in the memory 52 may be updated at any time based on various kinds of information that change over time.

The instructions stored in the memory 52 include, as explained above, for example, the range of the frequency in the frequency characteristic. Specifically, for example, in the case of FIG. 4, the frequency range R1 is equivalent to the range of the frequency and is stored in the memory 52 as data readable by a computer. Therefore, the processor 51 sequentially reads out the instruction stored in the memory 52 and compares the instruction with the detection value of the vibration sensor 23.

Another instruction stored in the memory 52 includes, as explained above, for example, the range of the amplitude in the frequency characteristic. Specifically, for example, in the case of FIG. 6, the threshold R3 is equivalent to the range of the amplitude and is stored in the memory 52 as data readable by a computer. Therefore, the processor 51 sequentially reads out the instruction stored in the memory 52 and compares the instruction with the detection value of the vibration sensor 23.

Another instruction stored in the memory 52 includes, as explained above, for example, the range of the half value width of the peak waveform of the frequency spectrum in the frequency characteristic. Specifically, for example, in the case of FIG. 5, the threshold HT of the half value width of the peak waveform of the frequency spectrum is equivalent to the range of the half value width of the frequency spectrum and is stored in the memory 52 as data readable by a computer. Therefore, the processor 51 sequentially reads out the instruction stored in the memory 52 and compares the instruction with the detection value of the vibration sensor 23.

As explained above, the control method for the robot 1 is the control method for the robot 1 including the robot arm 10 and the force sensor 21 (the first force sensor) that detects an external force. The control method for the robot 1 includes step S14 for detecting vibration of the robot arm 10 and step S15 for resetting the force sensor 21 based on a detection value of the vibration.

Based on the detection value of the vibration in this way, it is possible to more accurately grasp that the end effector 17 and the robot arm 10 are in contact with a person or an object. Specifically, by comparing the detection value of the vibration and the instruction stored in the memory 52, it is possible to more accurately grasp that the end effector 17 and the robot arm 10 are in contact with the person or the object. Consequently, it is possible to reset the force sensor 21 at appropriate timing and maintain high detection accuracy of the force sensor 21. In particular, compared with when presence or absence of a force is detected based on only an output value of the force sensor 21, it is possible to reduce a probability of false recognition that the person or the object is not in contact, although the person or the object might be in contact. Therefore, it is possible to improve safety and reliability of the robot 1.

The robot 1 includes the robot arm 10, the force sensor 21 (the first force sensor) configured to detect an external force, the vibration sensor 23 configured to detect vibration of the robot arm 10, the memory 52 (the storing section) configured to store instructions readable by a computer, and the processor 51 (the processing section) configured to reset the force sensor 21 based on the instructions stored in the memory 52 and a detection value of the vibration sensor 23.

With such a robot 1, as explained above, since it is possible to reset the force sensor 21 at appropriate timing while preventing the false recognition that the person or the object is not in contact, the high detection accuracy of the force sensor 21 can be maintained. Therefore, it is possible to more accurately detect that, for example, the end effector 17 is in contact with the object or the like. It is possible to further stabilize the movement of the robot 1.

The control device 50 is a device that controls the robot 1 including the robot arm 10 and the force sensor 21 (the first force sensor) configured to detect an external force. The control device 50 detects vibration of the robot arm 10 and resets the force sensor 21 (the first force sensor) based on a detection value of the vibration. That is, the control device 50 receives a signal including vibration information of the robot arm 10 and outputs a signal for performing reset of an output value (correction of a measurement value of a force) of the force sensor 21 capable of detecting an external force applied to the robot arm 10. The control device 50 performs the reset of the force sensor 21 based on this signal. In this way, with the control device 50, it is possible to reduce a time lag by unitarily performing the detection of vibration and the output of the signal. It is possible to more highly frequently perform the reset of the force sensor 21.

In the robot 1 according to this embodiment, the force sensor 21 (the first force sensor) is provided further on the proximal end side than the robot arm 10. That is, the force sensor 21 shown in FIG. 1 is provided between the robot arm 10 and the base 110.

Since the force sensor 21 is provided in such a position, the force sensor 21 is capable of efficiently detecting an external force applied to the end effector 17 without depending on the posture of the robot arm 10. That is, since the force sensor 21 is provided on the proximal end side of the robot arm 10, the external force applied to the end effector 17 is collected in the force sensor 21, and is possible to efficiently detect the external force.

A position where the force sensor 21 is provided is not limited to the position shown in FIG. 1 and may be any position.

On the other hand, in the robot 1 according to this embodiment, the vibration sensor 23 is provided in the end effector 17. Since the end effector 17 is a part further on the distal end side than the robot arm 10, when the vibration sensor 23 is provided in the part, it is possible to detect vibration of the robot arm 10 with higher sensitivity.

A position where the vibration sensor 23 is provided is not limited to the position shown in FIG. 1 and may be any position.

In this embodiment, as explained above, the inertial sensor is used as the vibration sensor 23. The inertial sensor outputs an electric signal reflecting a physical quantity such as acceleration or angular velocity. Since the physical quantity receives the influence of vibration and fluctuates, the electric signal fluctuates according to the fluctuation in the physical quantity. Therefore, with the inertial sensor, a signal easily processed by the control device 50 is output. Therefore, the inertial sensor is useful as the vibration sensor 23.

The position where the vibration sensor 23 is provided is not limited to the end effector 17 and may be, for example, any position of the robot arm 10 if the vibration sensor 23 can detect vibration of the robot arm 10 in the position.

The vibration sensor 23 is not limited to the inertial sensor and may be the optical vibration sensor, the soundwave-type vibration sensor, and the like explained above. Examples of the optical vibration sensor include a sensor that optically measures the distance between the robot arm 10 and a reference point on the outside and detects vibration based on fluctuation in the distance.

Examples of a measurement principle of the force sensor 21 (the first force sensor) include a piezoelectric type, a strain gauge type, and a capacitance type. The piezoelectric type is desirably used. The piezoelectric type using quartz is more desirably used. That is, the force sensor 21 is desirably a sensor including quartz. The force sensor 21 including quartz generates an accurate charge amount particularly with respect to an external force having wide amplitude. Therefore, it is easy to achieve both of high sensitivity and a wide range. Therefore, the force sensor 21 including quartz is useful as the force sensor 21 used in the robot 1.

Sensors of a plurality of different types maybe used together as the force sensor 21.

The control method for the robot 1 based on the flowchart of FIG. 3 is usually immediately started again (the normal operation is immediately started) after the flow once ends (after the reset of the force sensor 21 is completed). Therefore, the reset of the force sensor 21 is repeatedly executed at a relatively short interval. High detection accuracy is maintained.

### Second Embodiment

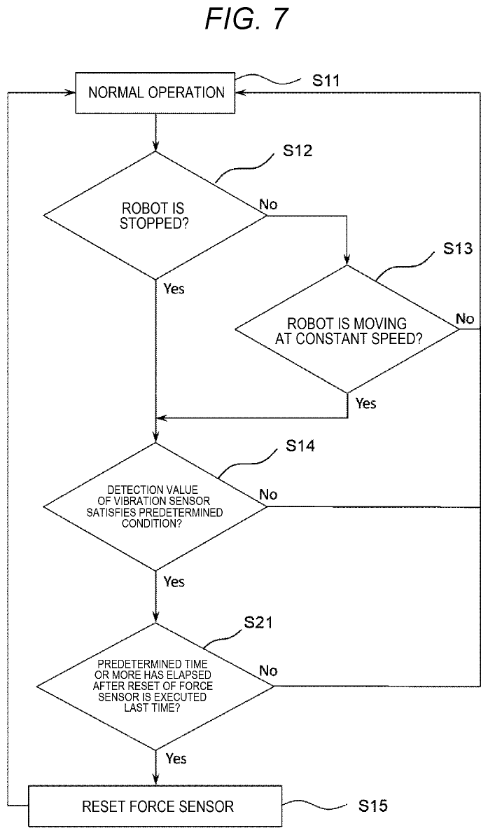

FIG. 7 is a flowchart for explaining a control method for a robot according to a second embodiment of the present disclosure.

In the following explanation, concerning the second embodiment, differences from the first embodiment are mainly explained. Explanation of similarities is omitted. In FIG. 7, the same steps as the steps in the first embodiment are indicated by the same signs.

This embodiment is the same as the first embodiment except that a step is added.

First, the robot 1 starts the normal operation (step S11).

When the detection value of the vibration sensor satisfies the predetermined condition (Yes in step S14), the control device 50 determines whether a predetermined time or more has elapsed after the reset of the force sensor 21 is executed last time (step S21). Specifically, the control device 50 stores a history of the reset of the force sensor 21 in the memory 52 and compares time when the reset of the force sensor 21 is executed last and the present time. The control device 50 calculates an elapsed time from the last execution. If a result of the calculation is the predetermined time or more, the control device 50 determines that the predetermined time has elapsed. If the calculation result is less than the predetermined time, the control device 50 determines that the predetermined time has not elapsed.

The predetermined time affects a frequency of repetition of the reset of the force sensor 21. Therefore, the frequency of the reset only has to be increased, that is, the predetermined time only has to be reduced in order to maintain high detection accuracy of the force sensor 21. On the other hand, in order to reset the force sensor 21, as explained in the first embodiment, it is necessary to satisfy the condition that the robot 1 is stopped or is moving at the constant speed. Therefore, it is unrealistic to endlessly increase the frequency of the reset in order to prevent the movement of the robot 1 from being limited. Therefore, it is also requested to reduce the frequency of the reset to keep deterioration in the detection accuracy of the force sensor 21 within an allowable range.

When determining that the predetermined time or more has elapsed after the reset of the force sensor 21 is executed last time (Yes in step S21), the control device 50 shifts to step S15 as in the first embodiment.

On the other hand, when determining that the predetermined time or more has not elapsed after the reset of the force sensor 21 is executed last time (No in step S21), the control device 50 shifts to step S11.

As explained above, step S15 is the same as step S15 in the first embodiment. Consequently, it is possible to minimize deviation between the measurement value of the force sensor 21 and a true value.

After the execution of step S15, the control device 50 may cause the memory 52 to store time after the execution according to necessity. Consequently, when step S21 is executed next time, it is possible to calculate an elapsed time after step S21 is executed last time.

With the control method for the robot 1 based on the flowchart of FIG. 7, it is possible to perform the reset of the force sensor 21 at appropriate timing. High detection accuracy is maintained.

According to the second embodiment explained above, it is possible to exert the same effects as the effects in the first embodiment.

The control device 50 performs steps S11, S12, S13, S14, S15, and S21.

### Third Embodiment

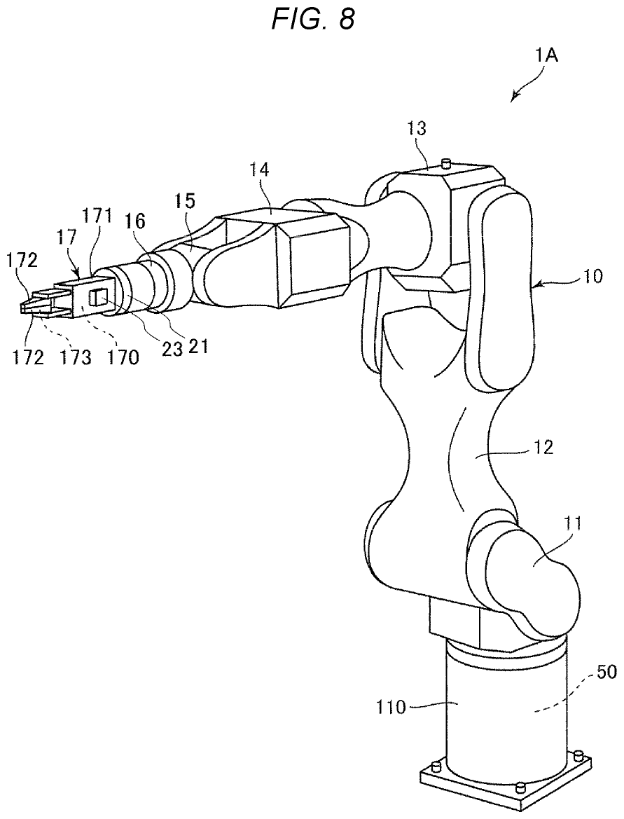

FIG. 8 is a perspective view showing a robot according to a third embodiment of the present disclosure.

In the following explanation, concerning the third embodiment, differences from the embodiments explained above are mainly explained. Explanation of similarities is omitted. In FIG. 8, the same components as the components in the first embodiment are indicated by the same reference numerals.

In the robot 1 shown in FIG. 1 explained above, the force sensor 21 is provided further on the proximal end side than the robot arm 10. On the other hand, in a robot LA shown in FIG. 8, the force sensor 21 (the first force sensor) is provided further on the distal end side than the robot arm 10. That is, the force sensor 21 shown in FIG. 8 is provided between the robot arm 10 and the end effector 17.

Since the force sensor 21 is provided in such a position, the force sensor 21 is capable of efficiently detecting an external force applied to the periphery of the end effector 17 that particularly easily comes into contact with a person or an object.

According to the third embodiment explained above, it is possible to exert the same effects as the effects in the first embodiment.

A setting position of the force sensor 21 is not limited to the positions in the first embodiment and this embodiment and may be other positions, for example, the inside of the robot arm 10.

### Fourth Embodiment

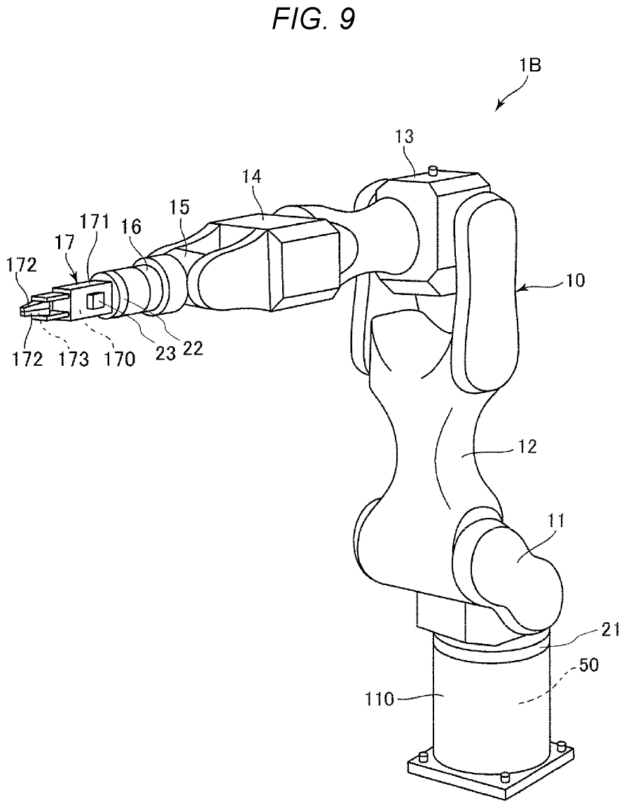

FIG. 9 is a perspective view showing a robot according to a fourth embodiment of the present disclosure.

In the following explanation, concerning the fourth embodiment, differences from the embodiments explained above are mainly explained. Explanation of similarities is omitted. In FIG. 9, the same components as the components in the first embodiment are indicated by the same reference numerals.

In the robot 1 shown in FIG. 1 explained above, the force sensor 21 is provided further on the proximal end side than the robot arm 10. On the other hand, in a robot 1B shown in FIG. 9, a force sensor 22 (a second force sensor) different from the force sensor 21 is added further on the distal end side than the robot arm 10. That is, the robot 1B shown in FIG. 9 includes two force sensors, that is, the force sensor 21 (the first force sensor) and the force sensor 22 (the second force sensor).

Since the robot 1B includes the force sensors 21 and 22, the robot 1B can more highly accurately detect an external force applied to the robot 1B. It is possible to further stabilize the movement of the robot 1B.

Both of the force sensors 21 and 22 are reset as in the first embodiment. Consequently, it is possible to maintain high detection accuracy concerning both of the force sensors 21 and 22.

According to the fourth embodiment explained above, it is possible to exert the same effects as the effects in the first embodiment.

The number of force sensors is not limited to one or two and may be three or more.

Only one of the force sensors 21 and 22 may be reset by the method explained above. The other may be reset by another method.

The embodiments of the present disclosure including the robot, the control device, and the control method for the robot are explained above with reference to the drawings. However, the present disclosure is not limited to this. The components of the sections can be replaced with any components having the same functions. Any other components may be added to the present disclosure.

The present disclosure may be a combination of any two or more configurations (features) in the embodiments explained above.

The robot according to the present disclosure is not limited to a single-arm robot if the robot includes the robot arm and may be other robots such as a double-arm robot and a SCARA robot. The number of arms (the number of joints) included in the robot arm is not limited to the number (six) in the embodiments explained above and may be one or more and five or less or seven or more.

What is claimed is:

1. A robot comprising:
a robot arm;
a first force sensor configured to detect an external force; and
a vibration sensor configured to detect vibration of the robot arm, wherein
the robot resets the first force sensor based on a detection value of the vibration sensor.

2. The robot according to claim 1, wherein the first force sensor is provided between the robot arm and a base.

3. The robot according to claim 1, wherein the first force sensor is provided between the robot arm and an end effector.

4. The robot according to claim 1, further comprising a second force sensor, wherein
the first force sensor is provided between the robot arm and a base, and
the second force sensor is provided between the robot arm and an end effector.

5. The robot according to claim 1, wherein the first force sensor is a sensor including quartz.

6. The robot according to claim 1, wherein the vibration sensor is an inertial sensor.

7. The robot according to claim 1, wherein the robot resets the first force sensor based on a frequency characteristic, which is the detection value of the vibration sensor.

8. A control device that receives a signal including vibration information of a robot arm and performs reset of an output value of a force sensor configured to detect an external force applied to the robot arm.

9. A control method for controlling a robot including a robot arm and a force sensor configured to detect an external force, the control method comprising:
detecting vibration of the robot arm; and
resetting the force sensor based on a detection value of the vibration.
